(19) United States
(12) Patent Application Publication
(10) Pub. No.: US 2011/0160628 A1
(43) Pub. Date: Jun. 30, 2011

(54) Shoulder and Backside Massager

(76) Inventor: Guoqing Ni, Shenzhen (CN)

(21) Appl. No.: 13/060,842

(22) PCT Filed: Nov. 13, 2008
(86) PCT No.: PCT/CN08/73048

§ 371 Date: Feb. 25, 2011

(30) Foreign Application Priority Data
Aug. 25, 2008 (CN) 200820146914.9

(51) Int. Cl. A61H 7/00

(52) U.S. Cl. 601/136

(57) ABSTRACT

A shoulder and backside massager includes a support body. Said support body comprises a balance weight portion and a massaging portion, said balance weight portion are separated and astraddle provided on the two fore-and-aft sides of the should. Said massaging portion is provided with a massage device, said balance weight portion is provided with a balance weight body (9), and said balance weight body is used for balancing said massage device.

### FIELD OF THE INVENTION

The present invention relates to massage device, and more particularly, to a convenient shoulder and backside massager.

### BACKGROUND OF THE INVENTION

The existing massage device always massages human body by manner of beating, so as to accelerate blood circulation and relax muscle.

The existing massage device is always in the form of hand-hold. When using, the user should hold the massage device, and contact the massage head of the massage device with the portion of the human body that needed to be massaged. The massage function is achieved by beating the portion of the human body that needed to be massaged through the massage head driven by a motor or an electromagnet. Such kind of massage device should be hold by hand when using, which results in inconvenient usage. The massage can only be used when abutting against a chair back or in a bed, especially when massaging the backside of the human body. Consequently, the usage is limited, and the massage effect is also reduced.

### SUMMARY OF THE INVENTION

The objective of this invention is to overcome the problem of inconvenient usage, when employing a massager in prior art, and to provide a convenient shoulder and backside massager without holding by hand when using.

In order to solve the above-mentioned technical problem, the present invention provides a shoulder and backside massager, which comprises a support body comprising a balance weight portion and a massaging portion, the balance weight portion and the massaging portion are separated and astraddle provided on the two fore-and-aft sides of the should;

the massaging portion is provided with a massage device; the balance weight portion is provided with a balance weight body for balancing the massage device.

In the shoulder and backside massager in present invention, the support body has a V shape, a U shape, a semiannular shape, an arc shape or an annular shape; the balance weight portion is the two sides of the support body, and the massage portion is the curve portion of the support body; the support body is made in one piece, or is made up of two separately independent portions.

In the shoulder and backside massager in present invention, the support body comprises a front sheet and a rear sheet which are combined directly on the edges thereof, or combined indirectly through a overcast seam; the balance weight body and massage device are installed in a space formed between the front sheet and the rear sheet; the front sheet and the rear sheet have a V shape, a U shape, a semiannular shape, an arc shape or an annular shape.

In the shoulder and backside massager in present invention, a combination device for opening and closing the space between the front sheet and the rear sheet is provided between the front sheet and the rear sheet; the combination device may be a slide fastener, a snap fastener or a magic tape and so on.

In the shoulder and backside massager in present invention, a mounting sheet is fixed between the front sheet and the rear sheet.

In the shoulder and backside massager in present invention, the balance weight body is a sealed balance weight bag which is filled with one or more kinds of sand, soil, gelatin, liquid (such as water), soft silica gel and jelly; a combination device for combining the balance weight bag and the mounting sheet is arranged therebetween; the balance weight bag is located at the two sides of the mounting sheet. The combination device comprises buttoned button sets, a magic tape, a slide fastener, an oversewing, a pressing buckle, a loop buckle or a binder.

In the shoulder and backside massager in present invention, the massage device comprises a moving component installed in the space between the front sheet and rear sheet, a circuit board for controlling the operation of the moving component, and selecting keys connecting with the circuit board for selecting operation modes for controlling the moving component.

In the shoulder and backside massager in present invention, the moving component is arranged in a moving component fixing bag, the bottom and the left and right sides of the moving component fixing bag are sewn on the inner side of the rear sheet, and the top of the moving component fixing bag is attached to the inner side of the rear sheet via a combination device;

or the moving component fixing bag is fixed on the mounting sheet, and the moving component fixing bag is provided with a combination device for opening or closing the inner space thereof;

the mounting sheet is sewn on the inner side of the rear sheet, or the top end of the mounting sheet is sewn on the inner side of the rear sheet.

In the shoulder and backside massager in present invention, the moving component is mounted in a moving component protecting box.

In the shoulder and backside massager in present invention, the circuit board is mounted in a circuit board box, the circuit board box is fixed on a fixing sheet and the top of which is sewn on the inner side of the rear sheet, the fixing sheet is provided with a combination device for fixing the circuit board box, one end of the combination device is fixed on the fixing sheet and the other end of the combination device is connected with the fixing sheet through the combination device;

or the circuit board box is placed in a circuit board box fixing bag which is fixed on the mounting sheet, and the circuit board box fixing bag is provided with a combination device for opening or closing itself;

the mounting sheet is in the form of one-piece or multi-pieces.

In the shoulder and backside massager in present invention, each of two sides at the lower end of the balance weight portion is provided with a hole, a massage handle or a hollow air bag is provided via the hole.

In the shoulder and backside massager in present invention, top material with a certain depth is sewn on the tops of the front sheet and rear sheet; and/or bottom material is sewn on the bottoms of the front sheet and rear sheet, the bottom material is soft material and/or the bottom material is provided with an air bag inside.

In the shoulder and backside massager in present invention, the shoulder and backside massager further comprises a buckle structure, which comprises a snap fastener, an ouch, and an elastic binder arranged at the inner side of the support body.

In the shoulder and backside massager in present invention, the selecting keys and the circuit board are installed in separate controllers, and conductively or communicatively connected to the massage device; or the selecting keys are arranged on the front sheet.

In the shoulder and backside massager in present invention, high temperature-resistant and/or cooling material or device are arranged between the front sheet and rear sheet; a light emitter (such as a lamp) and/or massage boulder are provided at the outside of the rear sheet.

By implementing present invention, following technical effects can be achieved. The support body is astraddle provided on the two sides of the shoulder, and using the balance weight body to balance the weight of the massage device, so that the whole shoulder and backside massager can be hung over the shoulder of the user, and when using, the user doesn't have to use his hand, which brings in advantage of convenient usage.

### BRIEF DESCRIPTION OF THE DRAWINGS

So as to further explain the invention, an exemplary embodiment of the present invention will be described with reference to the below drawings, wherein:

FIG. 1 is an exploded perspective view of the shoulder and backside massager according to a first embodiment of present invention;

FIG. 2 is a view of the shoulder and backside massager without the rear sheet according to present invention;

FIG. 3 is a combination perspective view of the shoulder and backside massager according to present invention;

FIG. 4 is a sectional view of the mounting structure of the rear sheet of the shoulder and backside massager according to present invention;

FIG. 5 is an exploded perspective view of the electrical hammer of the shoulder and backside massager according to present invention;

FIG. 6 is a view showing beating the waist by using the shoulder and backside massager according to present invention;

FIG. 7 is a view showing beating the backside by using the shoulder and backside massager according to present invention;

FIG. 8 is a view showing beating the shoulder by using the shoulder and backside massager according to present invention;

FIG. 9 is a front view showing the usage of the shoulder and backside massager according to present invention;

FIG. 9B is a side view showing the usage of the shoulder and backside massager according to present invention;

FIG. 10 is an exploded perspective view of the shoulder and backside massager according to a second embodiment of present invention;

FIG. 11 is a sectional view of the mounting structure of the rear sheet of the shoulder and backside massager according to a second embodiment of present invention;

FIG. 12 is a view of the moving component fixing bag in one form of the shoulder and backside massager according to present invention;

FIG. 13 is a view of the moving component fixing bag in another form of the shoulder and backside massager according to present invention;

FIG. 14 is a sectional view of the mounting structure of the rear sheet of the shoulder and backside massager according to a third embodiment of present invention;

FIG. 15 is a front view of the shoulder and backside massager according to a fourth embodiment of present invention;

FIG. 16 is an exploded perspective view of the shoulder and backside massager according to a fifth embodiment of present invention;

FIG. 17 is a front view of the shoulder and backside massager according to a fifth embodiment of present invention;

FIG. 18 is a back view of the shoulder and backside massager according to a fifth embodiment of present invention;

FIG. 19 is a back view of the shoulder and backside massager according to a sixth embodiment of present invention;

FIG. 19B is a view of the shoulder and backside massager in another form according to a sixth embodiment of present invention;

FIG. 20 is a view showing the usage state of the shoulder and backside massager according to a sixth embodiment of present invention;

FIG. 21 is a front view of the shoulder and backside massager according to a seventh embodiment of present invention;

FIG. 22 is a front view of the shoulder and backside massager according to an eighth embodiment of present invention;

FIG. 23 is a front view of the shoulder and backside massager according to a ninth embodiment of present invention;

FIG. 24 is a front view of the shoulder and backside massager according to a tenth embodiment of present invention;

FIG. 25 is a back view of the shoulder and backside massager according to an eleventh embodiment of present invention.

### DETAILED DESCRIPTION OF THE PREFERRED EMBODIMENT

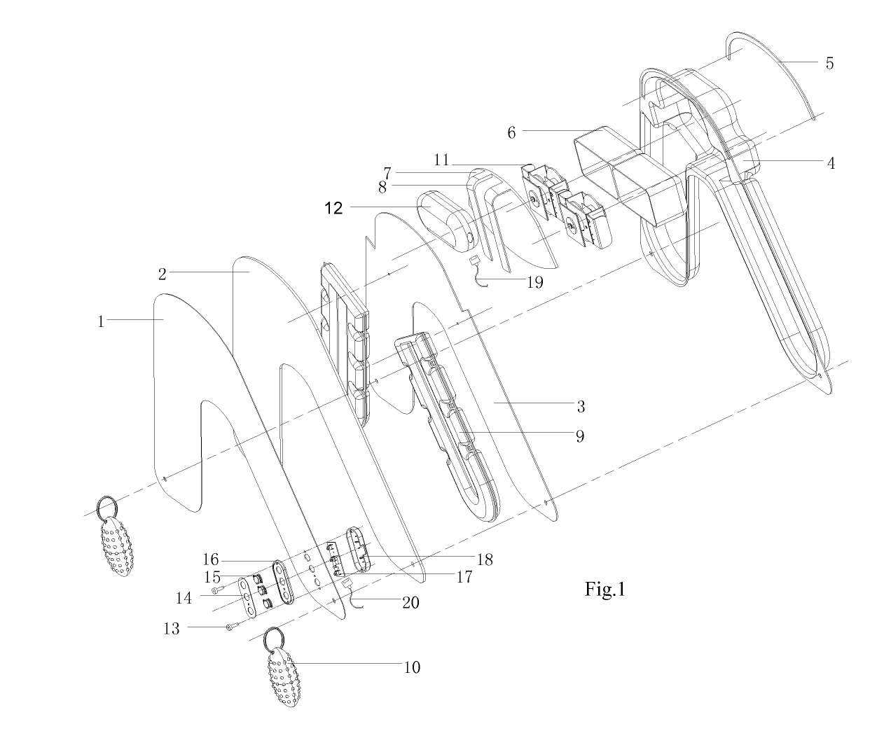

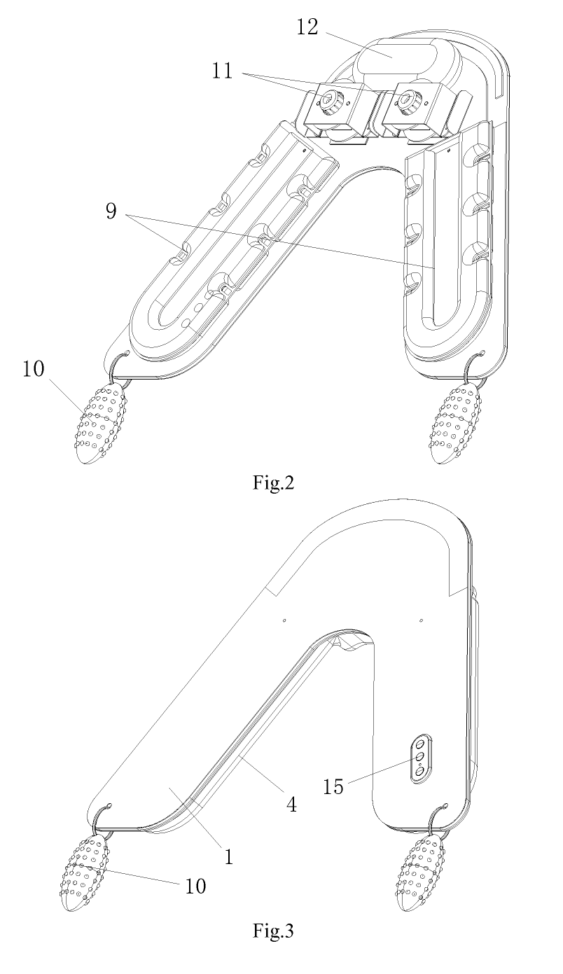

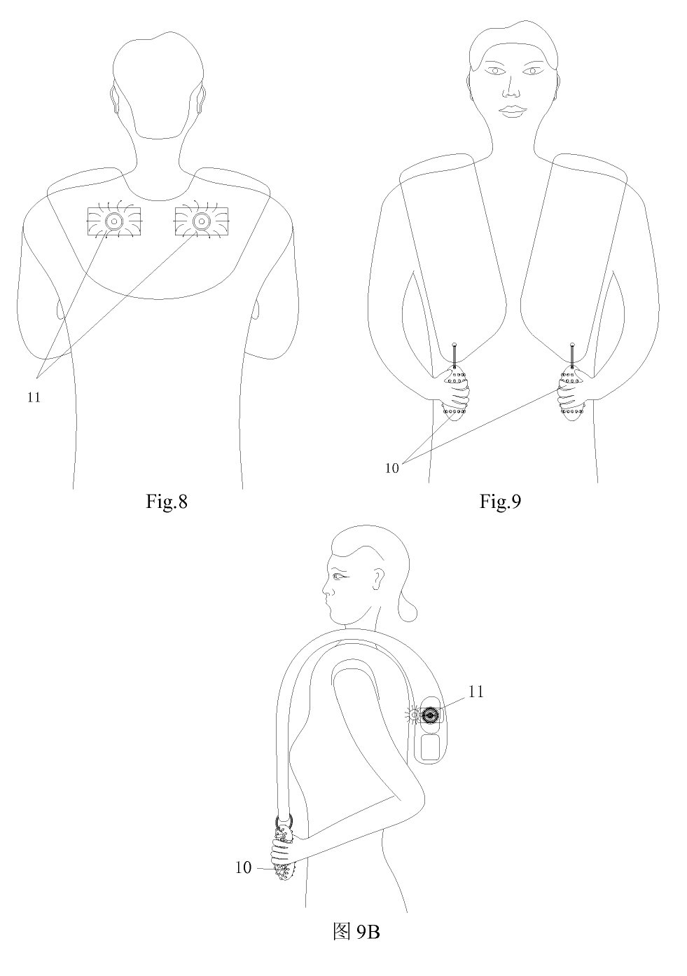

As shown in FIGS. 1-9, a detail embodiment of the shoulder and backside massager according to present invention is disclosed. The shoulder and backside massager comprises a support body. The support body may be astraddle provided on the shoulder of a user, and the balance weight portion and massaging portion of the support body are placed at two sides of the shoulder. The massaging portion is provided with a massage device for massaging the backside of the user. The balance weight portion is provided with a balance weight body 9 with a weight matching that of the massage device, so as to balance the weight of the massage device, so that the whole shoulder and backside massager can be hung over the shoulder of the user, and when using, the user doesn't have to use his hand, which brings in advantage of convenient usage.

In present embodiment, the support body is approximately in a V shape. The balance weight portion is the two sides of the V-shape support body, and the massage portion is the curve portion of the V-shape support body, so that the balance weight portion and the massaging portion are separated and astraddle provided on the two shoulders of the user, and the massage portion is fallen on the backside of the user.

The support body can be formed by the combination of V-shape front sheet 1 and rear sheet 4. As shown in the Figs, the rear sheet 4 can be made to be a slot shape. The front sheet 1 and rear sheet 4 are sewn at the edges thereof, so as to form a receiving space therebetween for receiving balance weight body 9 and massage device. Of course, the edges of the front sheet 1 and rear sheet 4 can be sewn incompletely, and slide fastener 5 can be provided at the un-sewn location, so as to open and close the space between the front sheet 1 and the rear sheet 4. Of course, the slide fastener also can be other combination device, such as buttoned button sets, a snap fastener, a magic tape, a sticker, an oversewing, a pressing buckle, a loop buckle or a binder and so on. For convenience of operation, the slide fastener 5 is arranged at the V-shape curve portion of the front sheet 1 and the rear sheet 4, so as to facilitate the enclosing of the massage device and balance weight body 9.

The front sheet 1 and the rear sheet 4 also can have other shapes which facilitate the astraddle installation on the shoulder of the user, such as a U shape, a semiannular shape, an arc shape or an annular shape and so on. The material of the front sheet and the rear sheet can be selected from cloth, leather, man-made leather and so on. The front sheet and rear sheet can be combined directly through such as oversewing or ultrasonic stitching, or be combined through an overcast seam, that is, oversewing or ultrasonic stitching and so on after packaging the edges of the front sheet and the rear sheet.

In order to facilitate the fixed installation of the balance weight body 9 on the front sheet 1, a V-shape mounting sheet 3 is provided. The edges of the two ends of the mounting sheet 3 is sewn to fix to the edges of the front sheet 1 and rear sheet 4. The curve portion of the V-shape can be opened for enclosing the balance weight body 9. In present embodiment, the balance weight body 9 is selected to be a balance weight bag. Button sets matching with each other are provided between the balance weight bag and the mounting sheet 3. Moreover, there are two balance weight bags mounted at the two ends of the V-shape mounting sheet 3. It can be understood that, the balance weight bag can be filled with other balance weight object, such as sand, soil, liquid (such as water), gelatin, plastic, soft silica gel, jelly, metal and other balance weight material. The connection between the balance weight body 9 and the mounting sheet 3 can employ a combination device which can use different ways such as buttoned button sets, a snap fastener, a magic tape, a sticker, a slide fastener, an oversewing, a pressing buckle, a loop buckle or a binder and so on. The shape of the mounting sheet 3 also can employ any other shapes.

A sponge shock insulator 2 is provided between the balance weight bag and the front sheet 1 for reducing shock, and making the whole massager softer.

The massage device comprises a moving component 11, a circuit board for controlling the operation of the moving component 11, and selecting keys 15 connecting with the circuit board. Key buzzers are provided according to the selecting keys for prompting operation of the keys. The key buzzers can be installed in the circuit board box, and also can be arranged in separate controller. In present embodiment, the moving component 11 is an electrical hammer. Of course, the moving component 11 also can be selected from other massage elements. The moving component 11 and circuit board are installed in the space formed between the front sheet 1 and rear sheet 4. The key circuit board 17 of the selecting keys 15 are mounted on the inside of the front sheet 1 through a key rear shell 18, and the selecting keys 15 are protruded and exposed of the outside surface of the front sheet 1 via the key front shell 16, so as to facilitate the operation of the user to select operation modes for controlling the moving component 11. Glasses 14 also can be added at the outside of the key front shell 16 for ornamenting. The key front shell 16 and key rear shell 18 can be fixedly connected through bolt 13. The key circuit board 17 is connected to the circuit board through key wire 20. Furthermore, a display device such as a digital display tube and so on, also can be installed at the outside of the front sheet 1 for display parameters such as work time, mode and so on. An automatic mode, a manual mode, work time, strength and so on also can be selected through the keys.

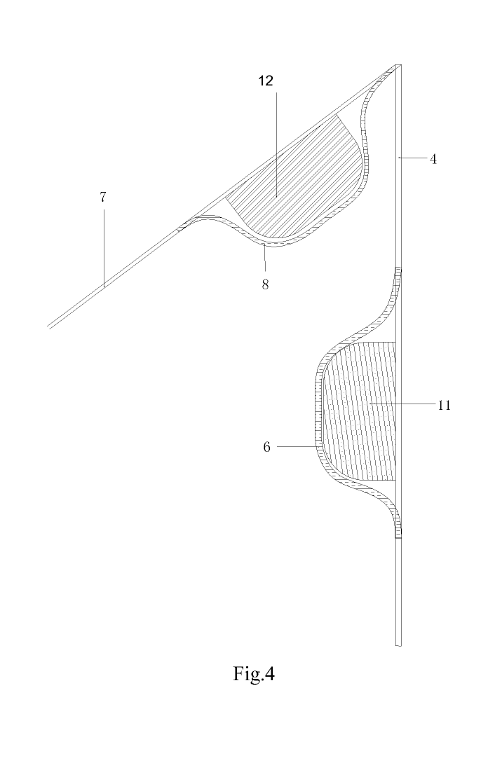

As shown in FIG. 4, the electrical hammer 11 is arranged in the moving component fixing bag 6 which is arrange at the inner side of the rear sheet 4, and at the curve portion of the V-shape. Moving component 11 is arranged in the moving component fixing bag 6 for beating and massaging. The bottom and the left and right sides of the moving component fixing bag 6 are sewn on the inner side of the rear sheet 4 to form a half-opened bag. After the moving component 11 has been installed in the bag, the bag can be sealed by a combination such as a snap fastener, a rivet, an oversewing or a slide fastener and so on. When assembling, the moving component 11 is fixed or place in the bag, and shock insulators (such as a cushion, cotton and so on) may be arranged between two moving components for preventing collision, and meanwhile, effects of safety and sound insulation also can be achieved. A wire hole is provided on the moving component fixing bag 6 for facilitating the piercing of the wire to provide work electrical power for the moving component 11. It can be understood that, the moving component fixing bag 6 is arranged between the mounting sheet 3 and the rear sheet 4, so that the moving component fixing bag 6 can be mounted on either the mounting sheet 3 or the rear sheet 4.

For facilitating the mounting of the circuit board, in present embodiment, the circuit board is mounted in a circuit board box 12, then the circuit board box 12 is fixed on a fixing sheet 7. The top of the fixing sheet 7 is sewn on the inner side of the rear sheet 4, and the fixing sheet 7 is provided with a flex 8 for binding the circuit board box 12. An end of the flex 8 is fixed on the fixing sheet 7 and the other end of the flex 8 is connected with the fixing sheet 7 through a magic tape. It can be understood that, the flex 8 also can use other combination devices to instead, such as buttoned button sets, a snap fastener, a magic tape, a sticker, a slide fastener, an oversewing, a pressing buckle, a loop buckle or a binder and so on. Furthermore, perforations also can be arranged on the circuit board box 12 for piercing of the flex 8, so as to bind the circuit board box 12.

When mounting, the circuit board box 12 is placed at the location of the flex 8, then the circuit board box 12 is pressed tightly by the flex 8, after that, the magic tape will be attached, so that, the circuit board box 12 is fixed on fixing sheet 7. In present embodiment, the circuit board box 12 is located above the moving component 11, so as to facilitate the electrical connection between them. It can be understood that, the conductive connection between the circuit board and the moving component 11 can be achieved through various manners such as moving component wire 19, connector and so on. The key circuit board 17 can be electrical connected to the circuit board through various manners such as wire, connector and so on. Through selections of the selecting keys 15, the circuit board can be triggered to control the work frequency, strength, interval and so on, so as to obtain different work modes. It can be understood that, the moving component fixing bag 6 is arranged between the mounting sheet 3 and the rear sheet 4, so that the moving component fixing bag 6 can be mounted on either the mounting sheet 3 or the rear sheet 4.

Furthermore, the lower end of the balance weight portion is provided with a hole, a handle 10 is provided via the hole for facilitating the holding of the user. A plurality of massage protuberances are arranged on the surface of the handle 10, so as to form a massage handle 10 for massaging. The handle also can be replaced by a hollow air bag.

As shown in FIG. 5, a detail embodiment of electrical hammer 11 is provided. It should be noted that, other moving component also can be used without restriction. The electrical hammer 11 comprises a base frame 24, a heel sheet 39 fixed on the base frame 24 through rivet 22, a spool spooled with a coil 42 arranged between the heel sheet 39 and the base frame 24, an iron core, and a massage head 40 mounted at a front end of the iron core. A via hole is provided on the heel sheet 39, spool and base frame 24, so as to facilitate reciprocating movement of the iron core and massage head 40 therein for realizing massage effect of beating. The iron core comprises circular iron sheet 23, big square cloth 25, circular iron sheet 28, circular cloth 29, slide-iron 30, small square cloth 32, slide-iron 33, small square cloth 34, circular iron sheet 35, circular cloth 36, circular iron sheet 37, circular cloth 38 with massage head 40 mounted at its one side in turn from the base frame 24, and all the above mentioned components are provided with a perforation by which a bolt 21 is getting through, and are locked through a nut 41 at the end of the bolt 21, so that a whole iron core and massage head 40 are formed. Square clothes are arranged between adjacent iron sheet and slide-iron as shock insulators. In such a way, the noise generated by the collision when the iron core working can be reduced, and the weight of the iron core can be adjusted by adding or reducing the number of the iron sheet and slide-iron. The massage head 40 can be made from various materials such as soft silastic, hard plastic and so on. When working, the iron core can be picked up for driving the reciprocating movement of the massage head 40 and realizing massage effect of beating via controlling the power supply of the coil 42. Furthermore, the coil of the moving component 11 also can be provided with overheating protection elements.

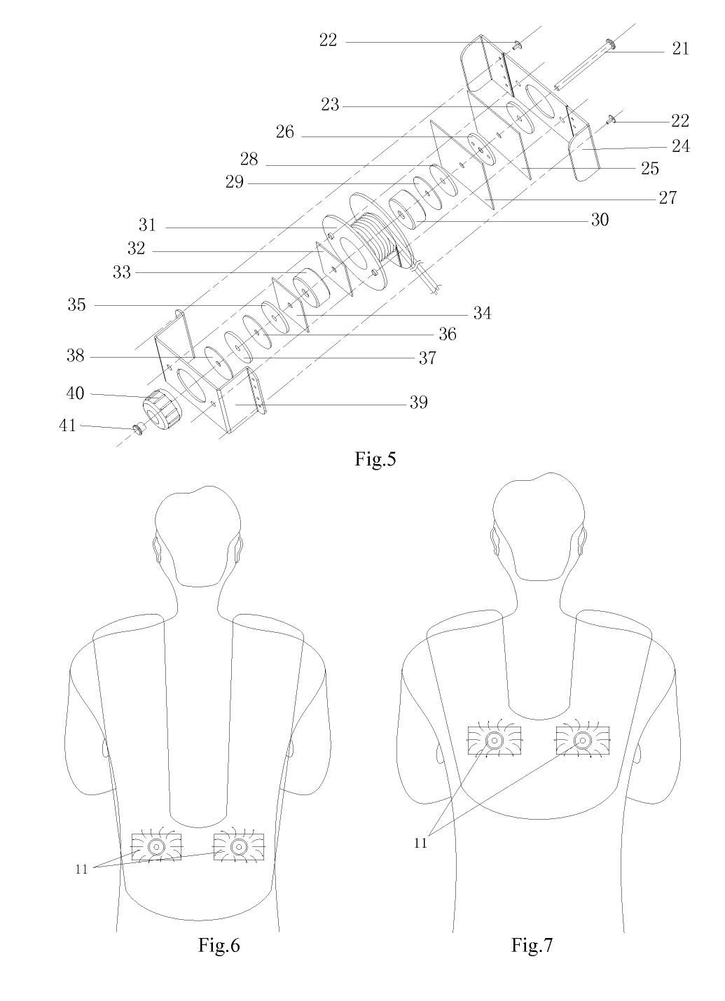

When using, the support body can be hung over the shoulder of the user, the balance weight portion is located in front of the user, and the massage portion is located in back of the user, and the location of the massage portion also can be adjusted according to actual need to massage the waist, backside or shoulder, as shown in FIGS. 6-8. In the front view, as shown in FIG. 9, the user also can grasp the handle 10 for hand massage, and the handle also can be a part of the balance weight portion.

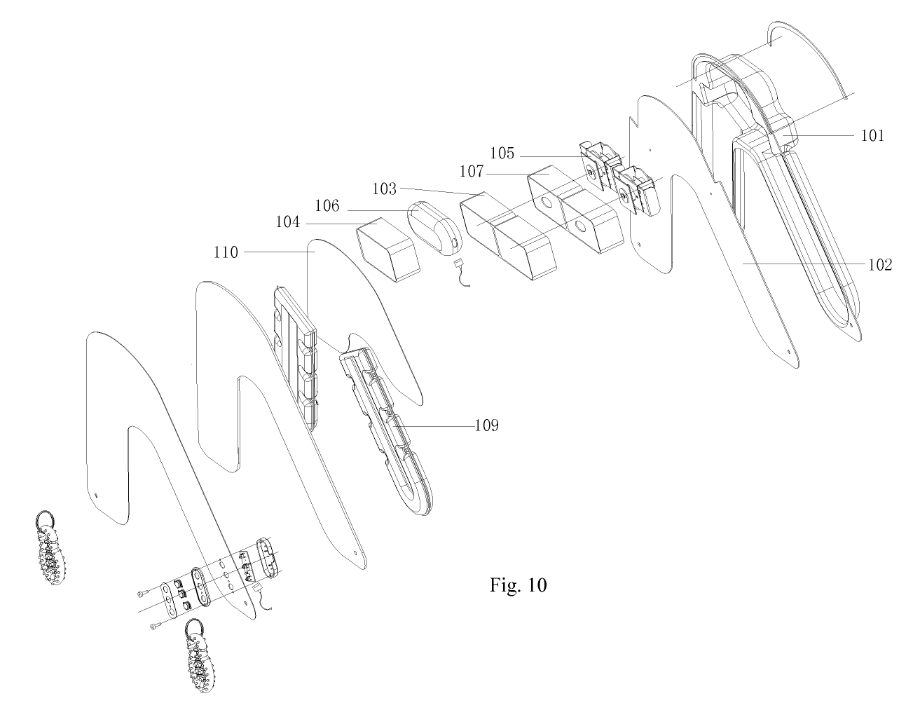

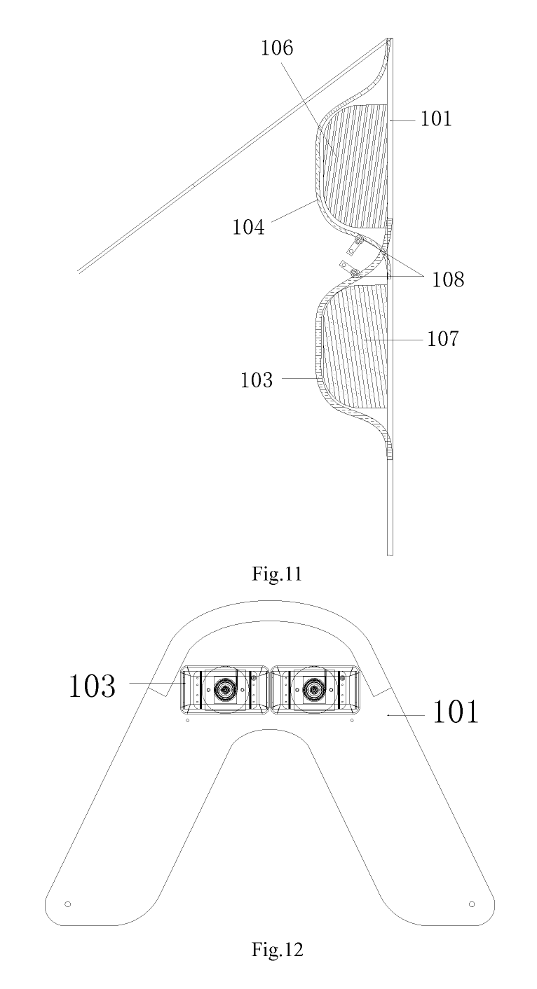

As shown in FIGS. 10 and 11, a second detail embodiment of the shoulder and backside massager according to present invention is disclosed. In present embodiment, the edge of the mounting sheet 102 is sewn to the rear sheet 101, and located at the inner side of the rear sheet 101. Separate moving component fixing bag 103 and circuit board box fixing bag 104 each for the mounting of moving component 105 and circuit board box 106 are sewed at the curve portion of the mounting sheet 102.

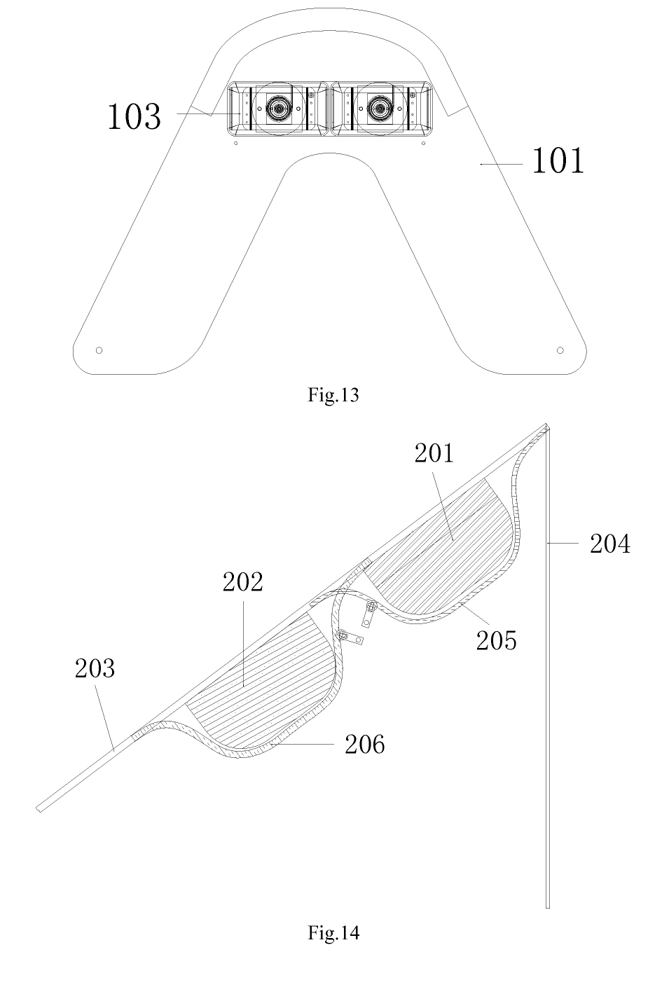

There may be two moving components 105. Correspondingly, there may be two independent fixing bags, as shown in FIG. 12. There also can be a whole fixing bag, at the middle of which, a separating band for separating such bag into two independent spaces is arranged. As shown in FIG. 13, such separating band can be various materials such as cloth, sponge, elastic cushion and so on. Further more, in order to prevent the moving component fixing bag 103 from being worn by the shock of moving component 105 when working, the moving component 105 can be enclosed into a moving component box 107, then the moving component box 107 is placed in to corresponding moving component fixing bag 103. For facilitating the piercing of the wire, a via hole for the wire is provided on the moving component box 107. The via hole for the wire is provided with a wear-resistant metal ring on its circumference. The moving component box 107 can be made from material with low rigidity, such as hard plastic, soft silastic, plastic foam and so on. The moving component fixing bag 103 and circuit board box fixing bag 104 is each provided with a slide fastener 18 for facilitating the enclosing of the moving component 105 and circuit board 106. It can be understood that, the slide fastener 18 also can be replaced by other combination device such as a fastener, a snap fastener and so on.

The moving component fixing bag 103 and circuit board box fixing bag 104 is each provided with a hole for facilitating the piercing of the wire. The moving component 105 and circuit board 106 can be electrical connected by the wire through the hole. The hole is provided with metal ring to prevent the wire from being worn by the moving component when working. Moreover, the wires also can be collected, and disordered disposition of wire also can be avoided. The rear sheet is provided with a hole for facilitating the piercing of the wire, and metal ring also can be provided at the circumference of the hole.

The balance weight body 109 is arranged at the two ends of the V shape of the mounting sheet 102. Fire cotton 110 is provided above the balance weight body 109 and at the inner side of the moving component fixing bag 103 and circuit board box fixing bag 104, so that good heat insulation function can be obtained. Meanwhile, the balance weight body 109 and fire cotton 110 can be placed in the same plane for filling and leveling up, so that the product structure may be more reasonable. The fire cotton also can be other high temperature-resistant and/or cooling material or device. The other structure of present embodiment is similar to the first embodiment, and not described for concision.

As shown in FIG. 14, a third detail embodiment of the shoulder and backside massager according to present invention is disclosed. The difference between the third detail embodiment and the second embodiment is that the fixing manner of the moving component 201 and circuit board box 202. The other structures of third detail embodiment and the second embodiment are similar, and not described for concision. In present embodiment, the edge of the mounting sheet is sewn to the rear sheet 204, and located at the inner side of the rear sheet 204. Above the mounting sheet, a fixing sheet 203 provided with a moving component fixing bag 205 and circuit board box fixing bag 206 each for the mounting of the moving component 201 and the circuit board box 202 is sewn at the top of the rear sheet 204. Such kind of mounting structure enable the moving component to have bigger movement margin, and better massage effect can be obtained.

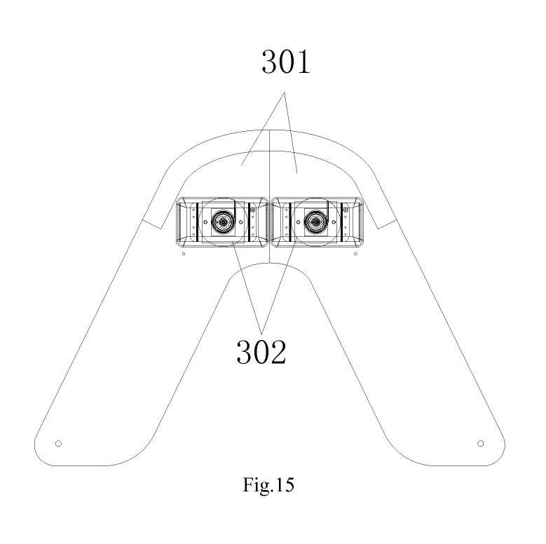

As shown in FIG. 15, a fourth detail embodiment of the shoulder and backside massager according to present invention is disclosed. In present embodiment, support body is a V shape comprised of two separate and independent portion which may be sewed together in the middle to form a whole. There are two independent corresponding moving component fixing bag 302 which are fixed separately. Such structure can be used in anyone of above embodiments.

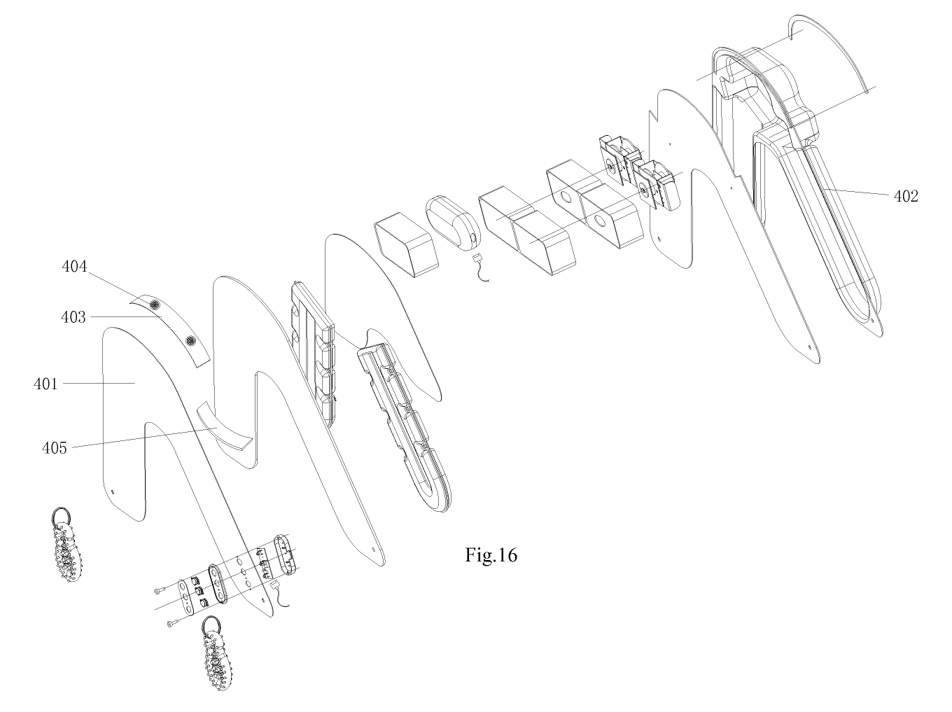

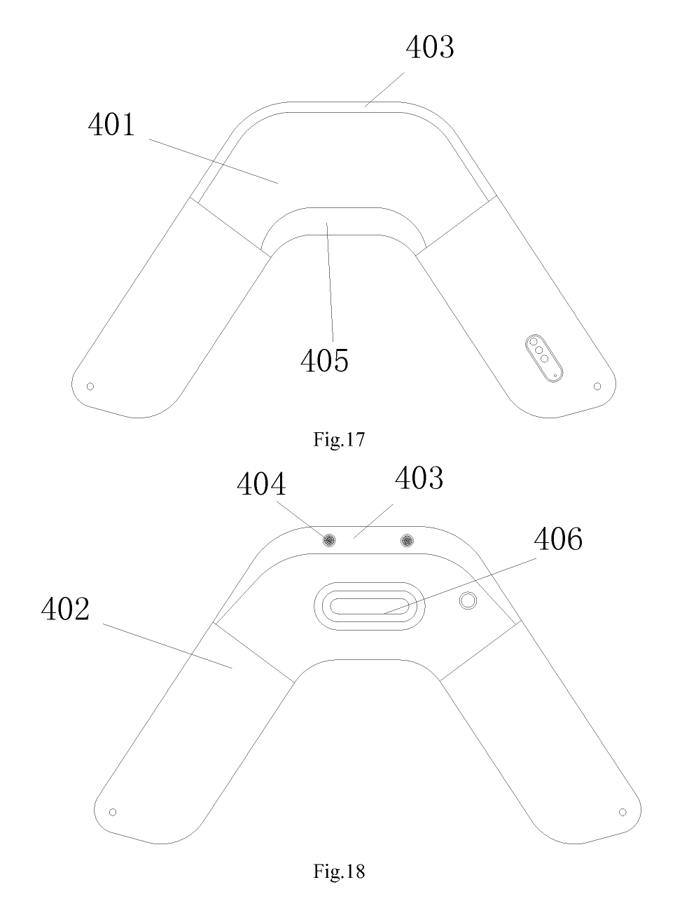

As shown in FIGS. 16-18, a fifth detail embodiment of the shoulder and backside massager according to present invention is disclosed. Top material 403 with a certain depth is sewn on the top of the V-shape of the front sheet 401 and rear sheet 402, so that inner space can be increased, and distortion, knob and so on that brought by directly oversewing due to the certain thicknesses of the moving component between the front sheet 401 and the rear sheet 402 also can be avoided. Furthermore, the top material 403 also can be provided with heat dissipation hole for dissipating hot generated by the work of the moving component and the circuit board.

Bottom material 405 is sewn on the bottom of the V-shape of the front sheet 401 and rear sheet 402. The bottom material is select from soft leather or cloth. Furthermore, the bottom material also can be provided with an air bag inside for massaging the neck. A wear-resistant cushion 406 also can be provided at the inner side of the rear sheet opposite the moving component for preventing abrasion.

The above mentioned structures in present embodiment can be used separately, or at the same time, and also can be used in anyone of the above mentioned embodiments.

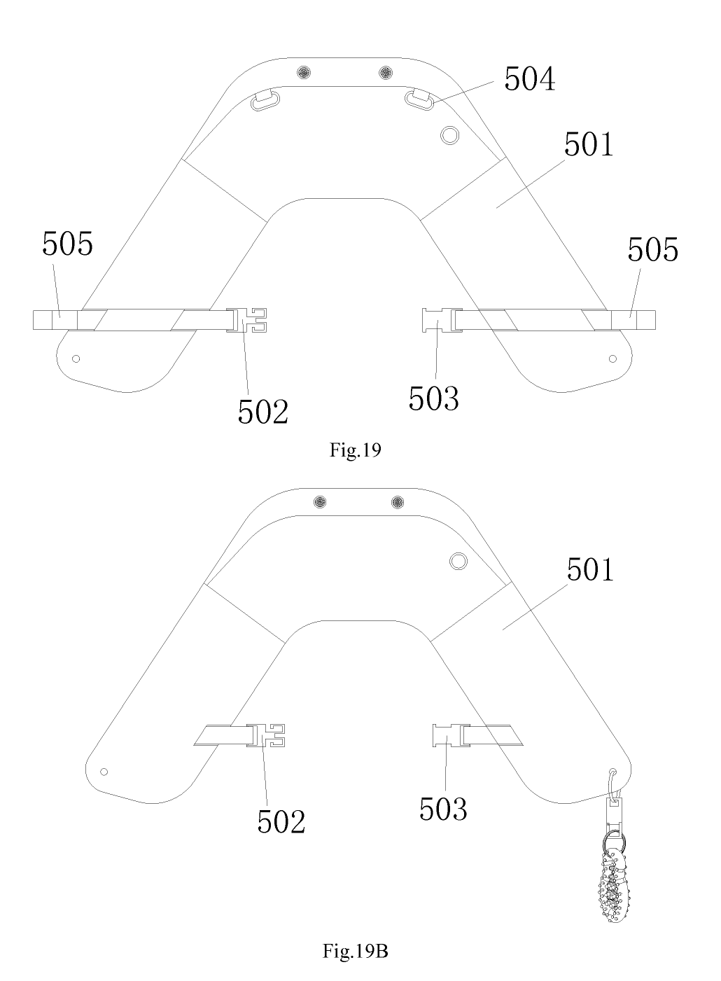

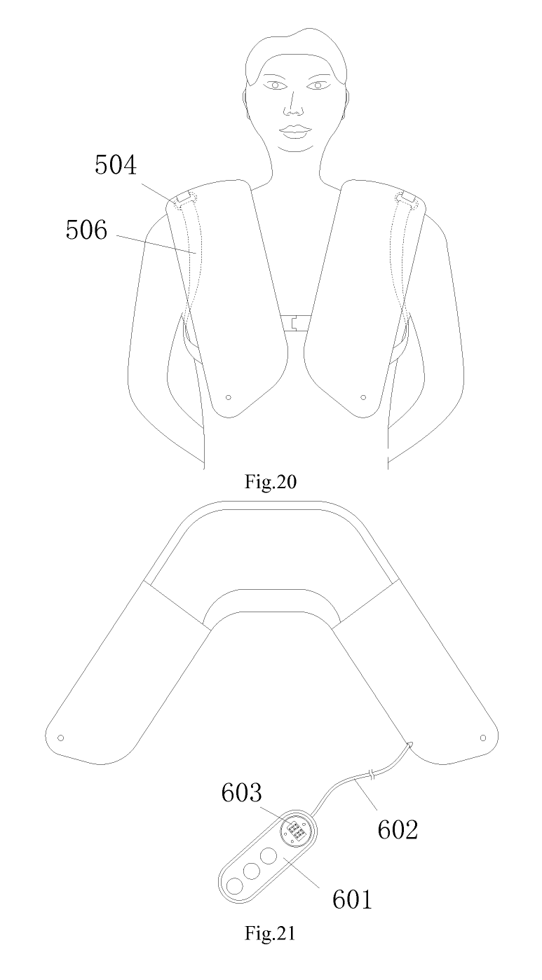

As shown in FIGS. 19 and 20, a sixth detail embodiment of the shoulder and backside massager according to present invention is disclosed. The shoulder and backside massager further comprises a buckle structure arranged at the inner side of the rear sheet 501 for binding the whole shoulder and backside massager to the body of the user. The buckle structure comprises a male snap fastener 502 and a female snap fastener 503 arranged at the two ends of the V-shape rear sheet 501 respectively. Through the snap of the male snap fastener 502 and female snap fastener 503, the ends of the V-shape rear sheet 501 are tensed.

The buckle structure further maybe comprises an ouch 504 arranged at the curve portion of the V-shape rear sheet 501, and an elastic binder 506 getting through the end of the ouch 504 and fixed to the end of the V-shape rear sheet 501 through a magic tape 505. When using, the binder 506 is astraddle provided on the backside of the user, so as to bind the whole shoulder and backside massager to the body of the user. As shown in FIG. 20, the user does not need to handle the shoulder and backside massager, and the hand of the user is freed, so the usage of the shoulder and backside massager is very convenient.

It can be understood that, the buckle structure can only comprise a male snap fastener 502 and a female snap fastener 503. Through the snap of the male snap fastener 502 and female snap fastener 503, the ends of the V-shape rear sheet 501 are tensed, as shown in FIG. 19B. Of course, the location of the buckle structure can be adjusted, and other manners also can be used. Moreover, the above structure in present embodiment also can be used in anyone of above embodiments.

As shown in FIG. 21, a seventh detail embodiment of the shoulder and backside massager according to present invention is disclosed. The difference between the seventh detail embodiment and the other above embodiments is that the key circuit board is arranged in an independent controller 601, and connected with the circuit board in the shoulder and backside massager via wire 602 to control the moving component. It can be understood that, the function, such as transformation, control and so on, of the circuit board in the shoulder and backside massager can be realized directly in the control 601, just need to arrange connecting circuit in the shoulder and backside massager, in such a way, safe capability can be provided. Moreover, besides the keys, a display screen 603 also can be arranged on the controller 601 for display operation information such as work mode, work time, remaining time, strength and so on. The other structures of present embodiment are similar to the above embodiments, and not described for concision.

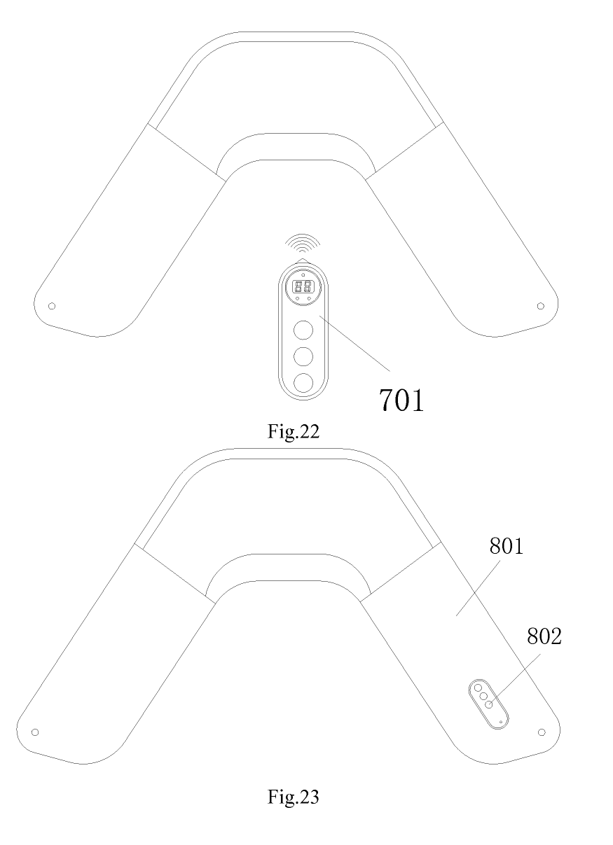

As shown in FIG. 22, an eighth detail embodiment of the shoulder and backside massager according to present invention is disclosed. The difference between the eighth detail embodiment and the above embodiments is that the key circuit board is arranged in a independent controller 22, and a remote control transceiver is arranged on the circuit boards in the independent controller and the shoulder and backside massager, such as IR remote controller, Bluetooth remote controller and so on, so that the circuit boards can be controlled by a wireless manner, then the usage is convenient. The other structures of present embodiment are similar to the above embodiments, and not described for concision.

As shown in FIG. 23, an ninth detail embodiment of the shoulder and backside massager according to present invention is disclosed. The difference between the ninth detail embodiment and the first embodiment is that the key circuit board is arranged at the inner side of the front sheet 801, and patterns 802 corresponding to the keys are sewn on the front sheet 801, so as to prevent the keys from being exposed. In such a way, the shoulder and backside massager is more beautiful and practical. The other structures of present embodiment are similar to the above embodiments, and not described for concision.

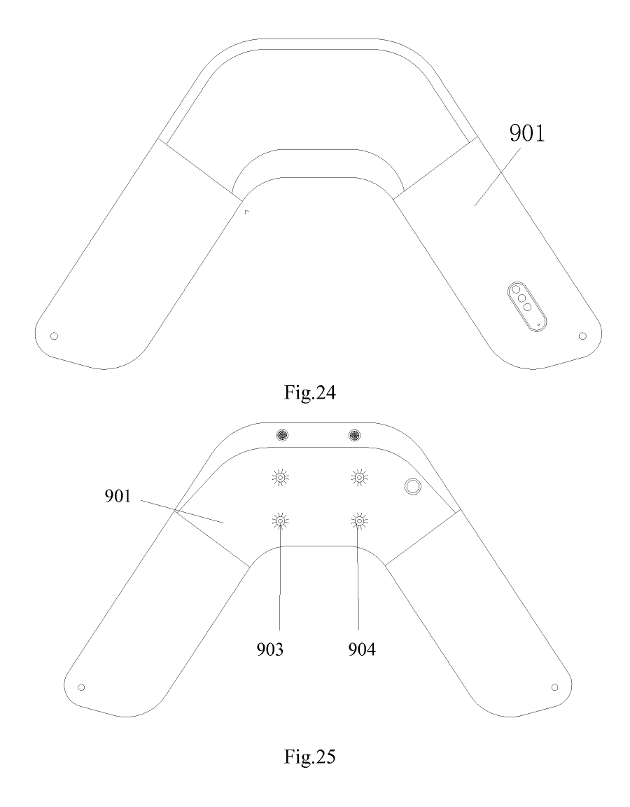

As shown in FIG. 24, a tenth detail embodiment of the shoulder and backside massager according to present invention is disclosed. The difference between the tenth detail embodiment and the above embodiments is that the front sheet 901 and/or the rear sheet are made from a plurality of sheets sewn together, that is, the front sheet 901 and/or the rear sheet are formed by a plurality of clothes, leathers and so on sewn together. Of course, the front sheet 901 and/or the rear sheet also can use a whole sheet. The other structures of present embodiment are similar to above embodiments, and not described for concision.

As shown in FIG. 25, a eleventh detail embodiment of the shoulder and backside massager according to present invention is disclosed, wherein, in present embodiment, a light emitter 903 and/or massage boulder 904 having functions of lighting, heating, massaging and so on are provided at the inner side of the rear sheet.

All of the features disclosed in the application documents are claimed as essential to the invention in so far as they are novel individually or in combination with respect to the prior art.

1. A shoulder and backside massager comprising:
a support body, which includes a balance weight portion and a massaging portion, the balance weight portion and the massaging portion are astride provided on the two fore-and-aft sides of the shoulder;
the massaging portion, which is provided with a massage device;
the balance weight portion, which is provided with a balance weight body for balancing the massage device.

2. The shoulder and backside massager according to claim 1, wherein the support body has a V shape, a U shape, a semiannular shape, an arc shape or an annular shape; the balance weight portion is the two sides of the support body, and the massage portion is the curve portion of the support body; the support body is made in one piece, or is made up of two separately independent portions.

3. The shoulder and backside massager according to claim 2, wherein the support body comprises a front sheet and a rear sheet which are combined directly on the edges thereof, or combined indirectly through a overcast seam, the balance weight body and massage device are installed in a space formed between the front sheet and the rear sheet; the front sheet and the rear sheet have a V shape, a U shape, a semiannular shape, an arc shape or an annular shape.

4. The shoulder and backside massager according to claim 3, wherein a combination device for opening and closing the space between the front sheet and the rear sheet is provided between the front sheet and the rear sheet.

5. The shoulder and backside massager according to claim 3, wherein a mounting sheet is mounted between the front sheet and the rear sheet.

6. The shoulder and backside massager according to claim 5, wherein, the balance weight body is a sealed balance weight bag which is filled with one or more kinds of sand, soil, liquid, gelatin, plastic, soft silica gel, jelly and metal; a combination device for combining the balance weight bag and the mounting sheet is arranged therebetween.

7. The shoulder and backside massager according to anyone of claims 3, wherein the massage device comprises at least one moving component installed in the space between the front sheet and rear sheet, a circuit board for controlling the operation of the moving component, and selecting keys connecting with the circuit board for selecting operation modes for controlling the moving component.

8. The shoulder and backside massager according to claim 7, wherein the moving component is arranged in a moving component fixing bag, the moving component fixing bag is sewn on the inner side of the rear sheet, and the moving component fixing bag is provided with a combination device for opening or closing the inner space thereof.

9. The shoulder and backside massager according to claim 8, wherein the moving component is mounted in a moving component protecting box.

10. The shoulder and backside massager according to claim 7, wherein the circuit board is mounted in a circuit board box, the circuit board box is mounted on a fixing sheet and the fixing sheet is sewn on the inner side of the front sheet or the rear sheet or the mounting sheet, the fixing sheet is provided with a combination device for fixing the circuit board box, the mounting sheet is in the form of one-piece or multi-pieces.

11. The shoulder and backside massager according to anyone of claims 1, wherein each of two sides at the lower end of the balance weight portion is provided with a hole, a massage handle or a hollow air bag is provided via the hole.

12. The shoulder and backside massager according to claim 3, wherein top material with a certain depth is sewn on the tops between the front sheet and rear sheet; and/or bottom material is sewn on the bottoms between the front sheet and rear sheet, the bottom material is soft material and/or the bottom material is provided with an air bag inside.

13. The shoulder and backside massager according to claim 1, wherein the shoulder and backside massager further comprises a buckle structure, which comprises a snap fastener, an ouch, and an elastic binder arranged at the inner side of the support body.

14. The shoulder and backside massager according to claim 7, wherein the selecting keys and the circuit board are installed in separate controllers, and conductively or communicatively connected to the massage device; or the selecting keys are arranged on the front sheet.

15. The shoulder and backside massager according to claim 2, wherein high temperature-resistant and/or cooling material or device are arranged between the front sheet and rear sheet.

16. The shoulder and backside massager according to claim 2, wherein a light emitter and/or massage boulder are provided at the one side of the front sheet or the rear sheet.

17. The shoulder and backside massager according to claim 7, wherein the moving component is an electrical hammer comprising a base frame, a heel sheet fixed on the base frame, a spool spooled with a coil arranged between the heel sheet and the base frame, an iron core, and a massage head mounted at the front end of the iron core; the iron core comprises a plurality of iron sheets, shock insulators and slide-irons assembled together for forming a whole iron core, and the shock insulators are arranged between adjacent iron sheet and slide-iron.

18. The shoulder and backside massager according to claim 7, wherein the moving component fixing bag is sewn on the mounting sheet, and the moving component fixing bag is provided with a combination device for opening or closing the inner space thereof, the mounting sheet is in the form of one-piece or multi-pieces.

19. The shoulder and backside massager according to claim 7, wherein the circuit board is mounted in a circuit board box, the circuit board box is placed in a circuit board box fixing bag which is sewn on the mounting sheet, and the circuit board box fixing bag is provided with a combination device for opening or closing itself; the mounting sheet is in the form of one-piece or multi-pieces.

20. The shoulder and backside massager according to claim 7, wherein the moving component is an electrical hammer comprising a base frame, a heel sheet fixed on the base frame, a spool spooled with a coil arranged between the heel sheet and the base frame, an iron core, and a massage head mounted at the front end of the iron core.
